(19) United States
(12) Patent Application Publication
(10) Pub. No.: US 2012/0136513 A1
(43) Pub. Date: May 31, 2012

(54) Accelerometer autopilot system

(76) Inventor: Ron Wayne Hamburg, Sacramento, CA (US)

(21) Appl. No.: 13/134,481

(22) Filed: Jun. 8, 2011

(51) Int. Cl. G05D 1/00

(52) U.S. Cl. 701/3

(57) ABSTRACT

The Accelerometer Autopilot System is an airplane and helicopter autopilot system that functions by a specially programmed software. The computer program directs aircraft navigation using accelerometer generated coordinates of altitude, latitude, longitude and distance travelled. The system uses four accelerometers that are specifically aligned by a solid-state compass to True North. Using fundamental Dynamics equations, the accellerations or decellerations are timed by an atomic clock and converted into velocities and distances. The distances are then either added to or subtracted from the departure point coordinates to obtain the new position coordinates. These new position coordinates will identify the real-time position of the aircraft as it is flying. When these coordinates are recorded during a programming flight the autopilot will track these coordinates as will be shown on the dashboard display screen. The pre-recorded coordinate course and the course azimuth will guide the aircraft to the destination point. This is accomplished without the use of gyros, GPS, or a VOR radio signal.

### BACKGROUND OF THE INVENTION

This invention is related to aircraft VOR autopilot systems, inertial navigation instruments, inertial land surveying equipment and to television DVD players. The method of operation of the Accelerometer Autopilot System involves some similarities found in all of the before mentioned systems. The primary purpose of this invention is to autopilot an airplane or a helicopter during flight navigation, in an emergency and as a flight training aid. Some of the differences in system operations include: No gyros in this system, tracking of the guidance system is to coordinates of altitude, latitude and longitude, rather than to a VOR radio signal, and the computer program used to process data, store data, retrieve data and to direct flight control adjustments is unique in several ways.

The coordinates of altitude, latitude and longitude used by the autopilot system are accelerometer generated and calculated using fundamental dynamics equations. The distances calculated are added or subtracted to the departure point coordinates and new position coordinates are determined. The units of measurement can be in feet, statute miles, nautical miles or degrees of latitude and longitude.

The computer program will determine a real-time position of the aircraft, record these coordinates on CD-ROM, to be used during an autopiloted flight, and monitor the accelerometer calculated distances while autopiloting a flight to a chosen latitude and longitude. The data obtained from the four accelerometers, solid-state compass, atomic clocks, four velocity meters, and four distance meters will be shown on the dashboard terrain display screen as real-time and pre-recorded coordinates.

In one aspect of operation the autopilot system will take the real-time coordinates of the aircraft and record these position coordinates during a programming flight or maneuver. The time interval of recording these coordinates can be from one second to thirty seconds. When flying at a constant velocity, level altitude and one compass course a longer time interval can be used.

These real-time recorded coordinates, then become the pre-recorded coordinates that the computer program of the autopilot system will track and guide the aircraft to coordinate coincidence. To track these pre-recorded coordinates, the programming flight data on CD-ROM is inserted into the onboard computer. This flight data is shown on the dashboard aeronautical sectional chart display screen which displays the terrain the aircraft will be flying over. The coordinates create a route of flight from departure point to destination and are shown simultaneously to the real-time coordinates.

As tracking begins, pre-recorded coordinates one second to thirty seconds ahead of the aircraft's real-time position are sighted from the display screen. The computer program will then direct the flight controls to adjust airspeed, yaw, pitch and roll of the aircraft to intercept and achieve coordinate coincidence between the real-time coordinates and the pre-recorded coordinates.

The amount of flight control adjustment that the autopilot will be directing is determined at the horizon display screen and the chart display screen. These two screens display altitude, atitude, vertical airspeed, compass course, terrain and the aircraft's real-time position. Any difference in the real-time position and the chosen pre-recorded position will be shown on the display screens. The difference in position will be a distance that can be calculated from the screen using the map scale and trigonometry.

In one example, a short calculated distance could require a rudder adjustment. In another example, a large calculated distance could require an aileron adjustment and course change, to intercept the pre-recorded coordinates.

When considering the pre-recorded accelerometer coordinates, the coordinates exhibit an altitude profile from the take-off runway, ascent, level, descent, approach and landing of the aircraft. The computer program is designed to track these coordinates and pass through them with the same velocity and altitude as they were recorded.

The pre-recorded coordinates shown on the terrain map screen, exhibit a flight route of one or more course changes from the departure point to the destination. The computer program is designed to direct microprocessor controlled flight adjustments to correspond to previous major flight adjustments and pass through the pre-recorded coordinates at the same velocity and compass course from take-off to landing of the aircraft.

The coordinate data shown on the display screens can show whether the real-time position of the aircraft is right or left, above or below of the chosen pre-recorded coordinate and also the numerical value of the accelerometer coordinate will verify any position difference. With this data the proper flight control adjustment can be made and this will result in an identical flight flown by the autopilot.

The microprocessors and servos used will be similar to other autopilot systems. The attachment of the servos to the mechanical flight controls of power, ailerons, flaps, elevator and rudder will be the same.

The alignment of the accelerometers to true north by the more accurate solid-state compass and the one second timing by atomic clocks and the one second compiling at the velocity meter and the distance meter is used by this invention.

The accelerometer alignment of the latitudinal acceleromter to true north and the longitudinal accelerometer at 90 deg. to the latitudinal accelerometer, the altitude accelerometer is aligned plumb and vertical and the fourth accelerometer is aligned horizontally with the compass course at the departure point.

The computer program will monitor the accelerometer data of altitude, latitude and longitude continuously while the aircraft's real-time position is compared to the coordinate position of the chosen route, recorded on CD-ROM, or the latitude and longitude coordinates identifying an airport, heliport or helipad.

### SUMMARY OF THE INVENTION

The Accelerometer Autopilot System is intended to autopilot an airplane or a helicopter in all phases of flight such as: taxiing, take-off, ascent, level, descent, approach and landing of the aircraft. The take-offs and landings can be at runways, offshore landings, heliports and helipads.

When this autopilot is used with first flying a programming flight or maneuver, both the airplane and helicopter record specific CD-ROM discs for each flight plan and destination. A blank CD-ROM disc can be inserted into the onboard computer and kept ready for recording and engaging the autopilot to fly a maneuver such as S-turns, circling, and hovering during any time of any flight.

The personnel and agencies that would find this autopilot system beneficial could include: Law Enforcement, Search and Rescue, Fire Fighting, Sightseeing, and Aircraft Missions.

In another mode of operation, latitude, longitude and altitude coordinates can be input into the onboard computer describing the location of the destination. This destination point can then be exhibited on the display screen against the appropriate sectional chart. With the departure point and destination point shown on the screen, and a line connecting them, this line then becomes the azimuth that the autopilot will be tracking.

The Airport Directory lists the latitude and longitude coordinates of all U.S. landing facilities, and these coordinates will allow this autopilot system to navigate to any airport.

The altitude, latitude and longitude coordinates of a heliport or helipad can be used by the helicopter, and a standard altitude profile can be used when autopiloting the helicopter to this destination point. The autopilot program is designed so that the main rotor tilt forward is in the direction of the azimuth to the destination point that was determined on the dashboard display screen. The functions of the autopilot computer program include: controlled vertical airspeed at lift-off, ascent to level flight at a pre-determined angle with the horizontal, altitude at level flight is selected in accordance with the Hemispherical Cruising Rule, the main rotor tilt forward is in the direction of the azimuth to the destination point, and the descent vertical airspeed is controlled during landing on the pre-determined coordinates. Program functions aren't limited to this.

In summary the autopilot system will navigate the airplane or helicopter to coordinate coincidence using the parameters contained within the visual images of the dashboard display screens.

This autopilot system will perform automatic navigation without any gyros, GPS (Global Positioning System), VOR radio signals or pilot assistance to a pre-determined destination.

Accelerometer generated coordinates of altitude, longitude and latitude, along with solid-state and magnetic compasses that reference course azimuths on the aeronautical sectional charts, that are stored in the terrain data base, are the main tools used to autopilot the aircraft.

The onboard computer will be programmed with the Accelerometer Autopilot System program and then a CD-ROM will be used to record and store altitude, latitude and longitude coordinates used to autopilot the aircraft. The CD-ROM is planned to operate as a television DVD player does, with record, play, fast forward, and rewind features, as when played by the onboard computer.

The ability of this autopilot system to reproduce an entire flight or just a portion of a flight and also to autopilot a maneuver during any flight is a useful navigational device, and is conducive of a system that utilizes the solid-state compass, the dashboard display screen and a memory chip to replace the gyro.

### BRIEF DESCRIPTION OF THE DRAWINGS

FIG. 1 is a block diagram for the aircraft autopilot showing input data flow to the dashboard display screens and output signals to the flight controls. (1) computer, (2) CD-ROM.

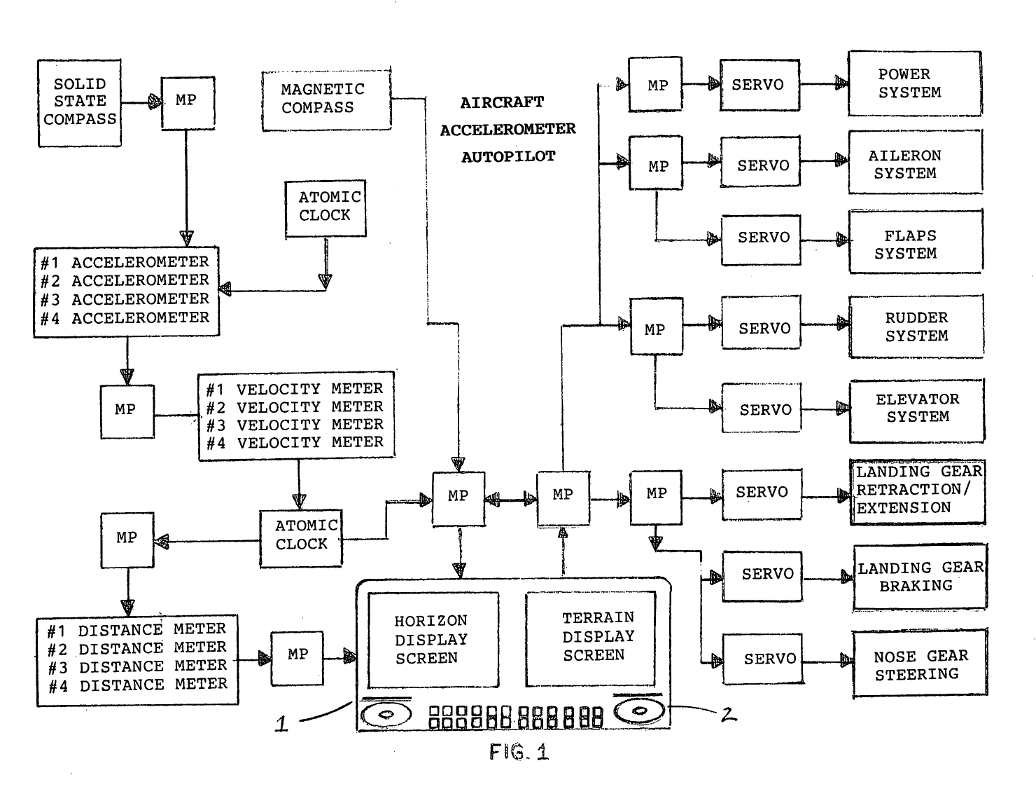

FIG. 2 is a block diagram for the helicopter showing input data flow to the dashboard display screens and output signals to the flight controls. (1) Computer, (2) CD-ROM.

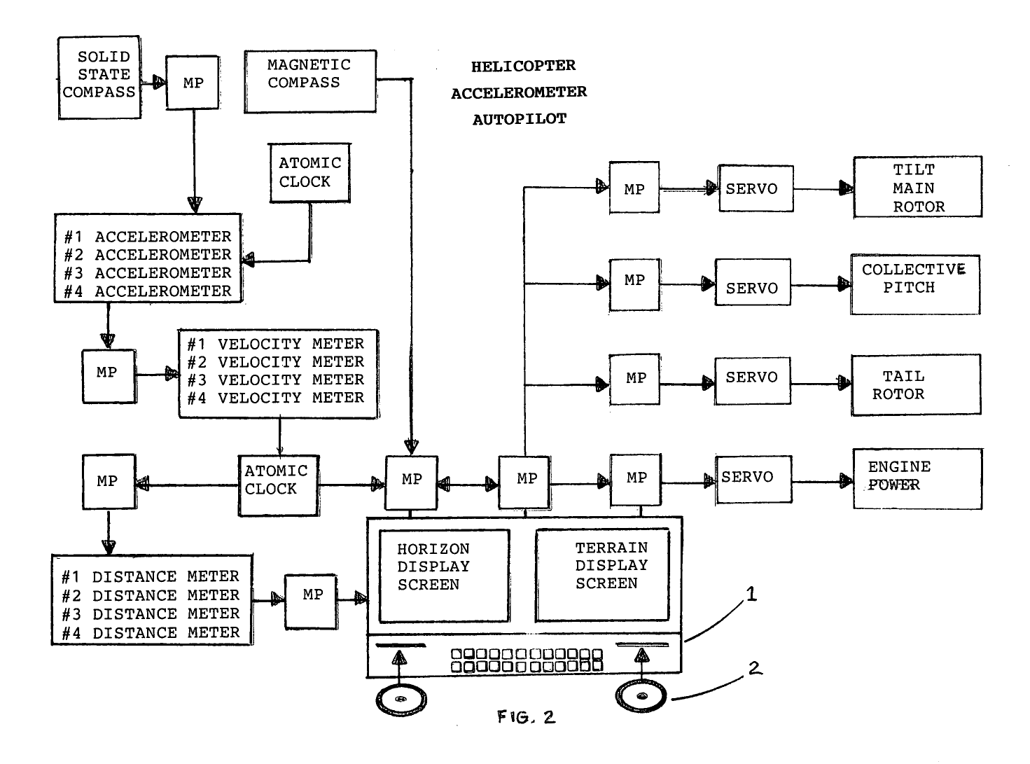

FIG. 3 is a sample list of accelerometer data where the timed accellerations are converted to velocities and then distances and then these distances are added to the departure point latitude. The latitude meter changes as to the distance travelled.

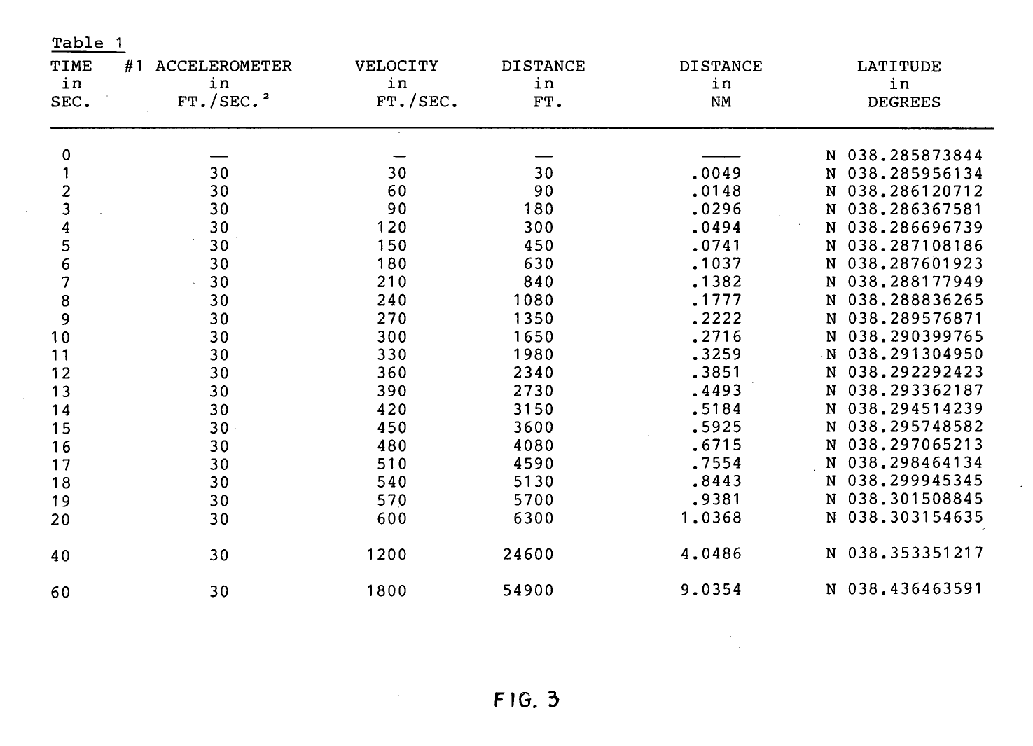

FIG. 4 is a depiction of a helicopter landing on a helipad during an autopiloted flight and how the coordinate meters will correspond to the helipad coordinates. (1) helipad, (2) cockpit coordinate meters, (3) helicopter landing on helipad.

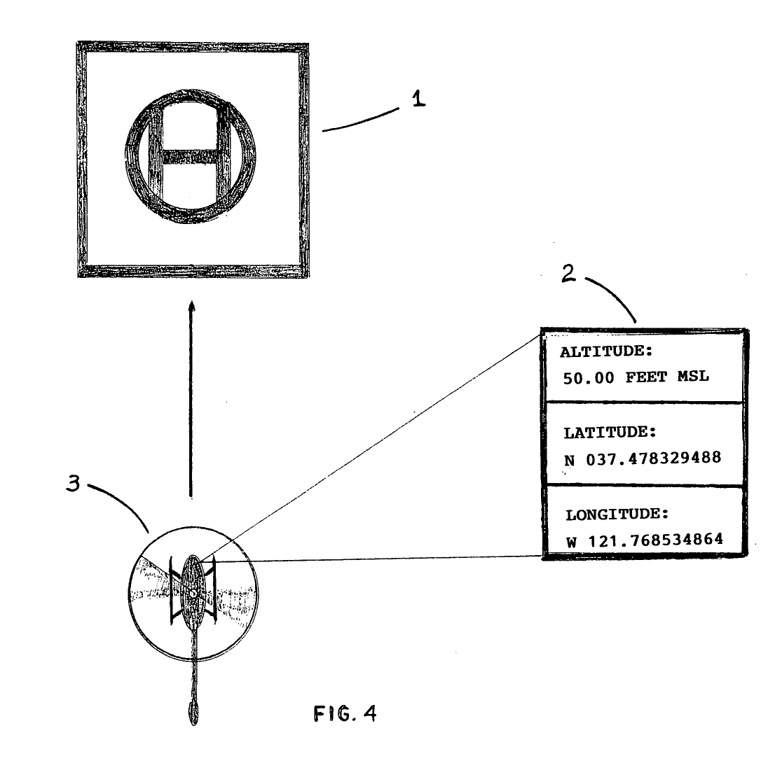

FIG. 5 is an airport diagram where the applications of the autopilot system is depicted. (1) an aircraft autopiloted on a taxiway. (2) an aircraft autopiloted during a take-off on the runway. (3) an aircraft autopiloted during a landing on a runway.

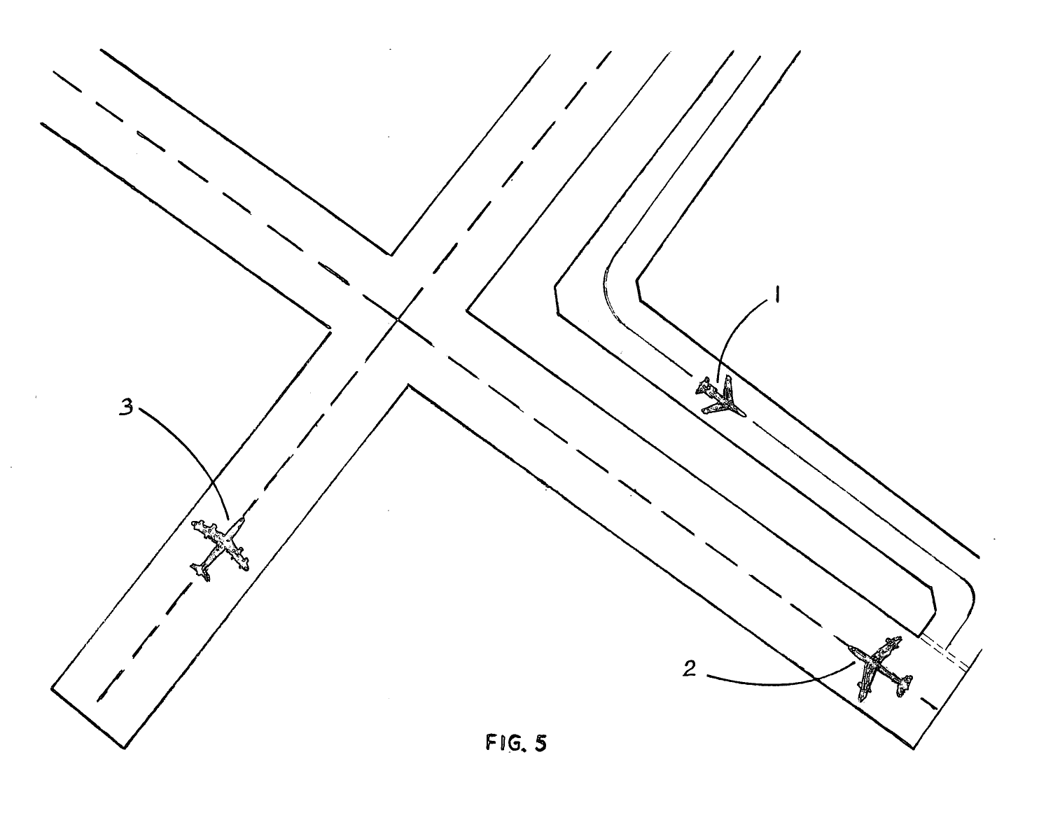

### DETAILED DESCRIPTION OF THE INVENTION

This autopilot system is designed to track an azimuth that is determined when a line is drawn that connects the departure point to the destination point. The departure point coordinates are the real-time coordinates that can be read from the aircraft's dashboard meters. The destination point coordinates of latitude and longitude need to be known, and then input into the onboard computer data base. The computer program will then exhibit the departure point, the course azimuth, the destination point, and the appropriate sectional chart of terrain and latitude and longitude. on the display screen.

The coordinates of latitude and longitude of the destination airport can be obtained from an Airport Directory of U.S. landing facilities.

The VOR autopilot systems used today are tuned to the NAVAID radio signal that is transmitted from the destination airport and determines the route they are flying. The airports that an aircraft can be autopiloted to, using the VOR autopilot, must have a VOR transmitter available. This amounts to approximately 60% of all U.S. landing facilities that have VOR available.

This new autopilot invention is designed to autopilot the aircraft to any coordinates that identifies an airport or a geographical location a pilot wants to fly to. 100% of the U.S. landing facilities would be reachable with this autopilot system.

The components such as the latitudinal accelerometer, that is aligned to True North by the solid-state compass, and the longitudinal accelerometer that is aligned 90 degrees to the latitudinal accelerometer will correspond to latitude and longitude positions shown on the charts exhibited on the cockpit display screen(s).

The computer program will convert timed accellerations into velocities, distances of feet, nautical miles, minutes of degrees, and then degrees of latitude from the latitudinal accelerometer and degrees of longitude from the longitudinal accelerometer.

In describing the operation of the Accelerometer Autopilot system when the pilot inputs the coordinates of the destination location into the onboard computer, several functions are directed by the computer program. A digital display will be shown of chosen latitude and longitude and the appropriate aeronautical sectional chart will be shown on the dashboard chart display screen. The departure point or real-time coordinate position will be shown simultaneously with the destination coordinates. At this time a compass course can be calculated where the azimuth connecting these two points will be followed by the autopilot program.

The autopilot system, when used by an airplane, can follow the latitude coordinate and the longitude coordinate that describes where the airport is. These coordinates can be found in the airport directory of most U.S. landing facilities. During operation of the autopilot, the computer program will convert spherical coordinates into plane coordinates by applying correction factors to the longitudinal distances. These distances vary when traveling toward the poles and observing the converging meridians. This is to insure accelerometer measured distances will correspond to the spherical coordinates used to identify these airports.

When this autopilot system is used with a helicopter, the system will accept the destination coordinates of latitude and longitude as they are input into the onboard computer. The computer will show the destination point on the display screen, show the departure point on the display screen, calculate the course azimuth, determine an altitude profile to follow, adjust flight controls to fly and land at destination point while monitoring the accelerometer data and this autopiloting will be accomplished without a pre-recorded flight or any pilot assistance.

In another aspect of operation, the autopilot system can be engaged by the pilot, during a flight where a maneuver, such as S-turns, circling or hovering can be flown by the autopilot.

The maneuver will be recorded as to the coordinates of altitude, latitude and longitude that the aircraft passes through during the maneuver. The computer program will then reproduce this maneuver by autopiloting the aircraft through those same recorded coordinates of altitude, latitude and longitude at the same airspeed as was recorded.

The components that are assembled to perform this process of aircraft navigation include: The Accelerometer Autopilot System computer program, the latitudinal accelerometer, the longitudinal accelerometer, the altitude accelerometer, the velocity/distance accelerometer, a velocity meter and a distance meter for each accelerometer, totaling eight digital meters, two atomic clocks, a solid-state compass, a magnetic compass, ten microprocessors, a DVD player/onboard computer with memory chips, a dashboard horizon display screen and a terrain map display screen, servo motors to each flight control.

The flight controls include, but not limited to: the airplanes ailerons, flaps, elevator, power, landing gear and nose gear, and for the helicopter, the main rotor tilt, the collective pitch and tail rotor anti-torque controls.

The assembly of components and the functions directed by the computer program enable this autopilot system to operate as has been described previously.

The Accelerometer Autopilot System will have this data available within the memory: The global WGS 84 coordinate system, Aeronautical Sectional Charts, Magnetic Variations between Magnetic North and True North with a precision of 1×10⁻⁹ of a degree, longitude distance corrections due to the converging meridians at the poles, accellerations and decellerations measured to the 1×10⁻⁶ feet, Display screen map scale and trigonometric relationships.

In describing some of the functions that the Accelerometer Autopilot System computer program will be directing, but not limited to, include: Precise one second timing of accellerations and decellerations, precise meter reading to 1×10⁻⁶ feet/sec.², precise timing of coordinate positions during flight recording, precise timing of the major flight control adjustments during the recording and storing of the coordinate data on CD-ROM, the accurate alignment of the latitudinal accelerometer to true north, this alignment to true north is to include a mathematical determination of the calculated alignment to true north using the main horizontal accelerometer and the solid-state compass. A calculated accelleration or decelleration can be determined for both the latitude and the longitude with reduction factors applied to the main horizontal accelerometer. This relationship is observed between the plumb altitude accelerometer and the main horizontal accelerometer, and also between the latitudinal, longitudinal and main horizontal accelerometers. The calculated accellerations of the latitude and longitude will be between the highest measured accelleration and zero accelleration depending on the angle measured between the main horizontal accelerometer and the true north alignment and equatorial alignment.

The calculated accellerations of latitude and longitude determined through a mathematical relationship rather from direct accelerometer measurement can be the primary means of latitude and longitude determination or this method can be used as a check and back-up system comparison to actually measured latitudinal and longitudinal accellerations.

Another mathematical relationship that is considered is the equation for velocity in terms of the accelleration and time, where a×t=v. This equation is used to determine the velocity in this autopilot system with no discrepancies when compiled at the velocity meter every one second. The integral of this equation is: ½ a×t², and is considered to be the equation of distance in terms of accelleration and time. When compiling the velocities every one second and determining the distance there is a difference in the measured distance and the calculated distance when comparing the result to the integral equation.

Table 1, is a compiled table showing the accuracy difference between a compilation process/method used by this autopilot system and the calculated result using the calculus equation.

That which is claimed:

1. A device to perform autopiloting of an airplane and/or a helicopter comprising of: a magnetic compass, a solid-state compass, atomic clock(s), four accelerometers, four digital velocity meters, four distance meters, a specialized computer program, memory chips, microprocessors, CD-ROM player/computer, dashboard display screen(s), servo(s) to flight controls, with all components performing functions that will navigate the aircraft to coordinate coincidence and the destination point.

2. A computer program: The Accelerometer Autopilot Program comprising of a process/method of operation where accelerometer generated coordinates of altitude, latitude, longitude and distance data are recorded on CD-ROM during a programming flight and will then be exhibited on the display screen(s) showing a coordinate course and a course azimuth.

3. The device as in claim 1, wherein the accelerometers measure axis specific accellerations and decellerations that are timed at one second intervals and compiled at the digital velocity meter and then this velocity meter is compiled at one second intervals, to be shown at the digital distance meter, where these distances can be added to or subtracted from the departure point coordinates to obtain new position coordinates.

4. The device as in claim 1, wherein the solid-state compass is used to automatically align the latitudinal accelerometer to True North every (10) ten miles of flight to insure that the accelerometer generated coordinates of latitude and longitude correspond to the aeronautical sectional charts that are shown on the dashboard display screen(s).

5. The device as in claim 1, wherein the alignment of the latitudinal accelerometer is also monitored at the display screen with the magnetic compass, solid-state compass, an image on the dashboard display screen by memory chip of recent elapsed time and recent orientation, this to be checked at regular time intervals during the flight.

6. The computer program of claim 2, wherein the amount of flight control adjustment is determined at the dashboard display screen using the map scale of the screen, the airspeed of the aircraft, the projected difference in distance of the real-time position coordinate and the pre-recorded chosen course coordinate when autopiloting the aircraft to coordinate coincidence.

7. The computer program of claim 2, wherein the autopilot system is directed to navigate to an input latitude and longitude coordinate and determining a course azimuth from the dashboard display screen to this destination location.

8. The computer program of claim 2, wherein the autopilot system is directed to reproduce a maneuver, that is recorded and autopiloted at any time of any flight.
